(19) United States
(12) Patent Application Publication
(10) Pub. No.: US 2025/0279463 A1
(43) Pub. Date: Sep. 4, 2025

(54) ELECTROCHEMICAL CELL FOR STORING ELECTRICAL ENERGY

(71) Applicant: AMPERE S.A.S., Boulogne Billancourt (FR)

(72) Inventors: Nicolas BESNARD, Guyancourt Cedex (FR); David LERAY, Guyancourt Cedex (FR)

(73) Assignee: AMPERE S.A.S., Boulogne Billancourt (FR)

(21) Appl. No.: 18/580,418

(22) PCT Filed: Jun. 21, 2022
(86) PCT No.: PCT/EP2022/066837

§ 371 Date: Jul. 31, 2024

(30) Foreign Application Priority Data
Jul. 22, 2021 (FR) FR2107969

(51) Int. Cl. H01M 10/04; H01M 10/0587; H01M 50/107; H01M 50/119; H01M 50/474; H01M 50/477

(52) U.S. Cl. CPC H01M 10/0468; H01M 10/049; H01M 10/0587; H01M 50/107; H01M 50/119; H01M 50/474; H01M 50/477; H01M 2220/20

(57) ABSTRACT

An electrochemical cell for an electrical energy storage device, in particular intended for a motor vehicle, comprising a plurality of electrodes (3) and a compression device (4) adapted to the variations in volume of the plurality of electrodes (3), the compression device (4) comprising a casing (5) and an at least partially elastically deformable return element (6) allowing the constant exertion of a suitable compression on the plurality of electrodes (3) in order to keep the various elements thereof in contact with one another and thus allow more homogeneous operation of the cell.

The present invention relates to an electrochemical cell for an electrical energy storage device, notably an electric battery. The invention relates also to an electrical energy storage device comprising said cell and a vehicle equipped with such a storage device and/or such a cell. The invention relates finally to a method for manufacturing an electrochemical cell.

In electric or hybrid vehicles, the current electric drive means involve electrical storage devices, or electric batteries, that are increasingly powerful in order to compete with the performance levels of heat engines. Increasing the electric drive performance levels relies largely on improving the range of the vehicle, for example by increasing the volume of the storage devices.

Conventionally, storage devices, also called “battery pack”, or more simply “battery”, comprise a plurality of cells, notably of lithium, or li-ion, type, which can be produced according to different architectures. The so-called cylindrical and prismatic cells consist of a winding or a stack of electrodes slipped into a rigid metal housing previously manufactured and sealed by a cover.

During the usage cycle of the cell, the winding or the stack of electrodes exhibits an expansion or a contraction by volume during charging and discharging phases respectively. The amplitude of such a volume variation depends on the active materials used. It is for example maximized when using silicon technology as the active material of the negative electrode. Moreover, a volume expansion of the elements is also observed during the life cycle of the cell, in particular with the ageing thereof.

Also, some types of electrochemical cells require, for them to operate correctly, the application of pressure on the winding or the stack of electrodes in order to favour the mechanical strength and the contacts between the different elements. This pressure is more particularly critical in the case of cells with solid electrolyte. This pressure also proves necessary in the case of a system which exhibits a respiration of large amplitude when charging and discharging, as discussed previously for the silicon technology, without which losses of contact between the materials are observed, affecting the lifetime of the battery.

Compression devices that aim to apply a pressure on the electrochemical cells, for example by means of spring systems or screwed plates, do exist at the module or battery pack level. These solutions are nevertheless usable only in the case of an electrochemical cell comprising a flexible packaging, that is say in the case of “pouch” type electrochemical cells. These solutions are nevertheless incompatible with the cells with rigid packaging.

The document U.S. Pat. No. 9,634,351 discloses an example of electrochemical cell with rigid packaging of which a winding of electrodes is held by a helical return element. The aim of such a return element is to facilitate the assembly of the cell by holding the winding of electrodes in position, but it does not have a winding compression function commensurate with the life of the cell. Notably, with the volume expansion of the winding of electrodes, a pressure and local mechanical strains are exerted on the contact surfaces between the return element and the winding of electrodes. Since this pressure is applied locally, it is likely to result in a shearing of the outer elements of the winding of electrodes. In addition, this local pressure variation can lead to local non-uniformities between compressed and non-compressed areas, potentially leading to non-uniformities of ageing of the cell and therefore a degradation of the operation thereof.

The present invention lies within this context and aims to resolve the abovementioned drawbacks by proposing an electrochemical cell equipped with a compression device for the winding or the stack of electrodes in the case of the electrochemical cells with rigid packaging, by performing this compression within the cell, and not at the module or battery pack level. This system makes it possible to apply a constant pressure regardless of the state of charge of the battery and its state of ageing.

The present invention proposes an electrochemical cell comprising a plurality of electrodes, a compression device for the plurality of electrodes and a rigid packaging capable of receiving the plurality of electrodes and the compression device, the compression device comprising:
at least one return element that is at least partly elastically deformable configured to be deformed between a first configuration and a second configuration based on a volume of the plurality of electrodes, the at least one return element being interposed between the plurality of electrodes and at least a part of the rigid packaging;
a metal shell comprising one or more parts, the shell being interposed between the at least one return element and the plurality of electrodes and the shell surrounding the plurality of electrodes so as to have at least one area of overlap of two distinct portions of the shell of which a surface varies according to the volume of the plurality of electrodes.

Notably, the at least one return element can comprise a rigid body and a plurality of elastically deformable fins, linked to the body and having an inclination α relative to the latter, a value of the inclination α being maximal when the at least one return element is in the first configuration such that the plurality of fins extends to protrude from the body, and a value of the inclination α being minimal when the at least one return element is in the second configuration, at least the plurality of fins extending into contact with the shell.

Alternatively the at least one return element can have an “accordion” structure comprising a plurality of corrugations or of elastically deformable folds of which a form and/or angles β vary according to the volume of the plurality of electrodes.

Notably, the shell can be centered on a main axis, a minimal surface of the area of overlap being delimited by an angular segment, derived from the main axis and defined in a plane orthogonal to the main axis, between 10 and 30°, notably 10 and 20°.

The plurality of electrodes can be disposed according to a winding centered on an axis of extension and/or according to a stack extending along an axis of extension, the at least one return element and/or the shell being centered on such an axis.

According to an exemplary embodiment, the compression device can comprise a plurality of return elements disposed along at least one dimension, notably a longest dimension, of the plurality of electrodes and/or of the shell, the plurality of return elements extending over all or part of said dimension. The plurality of return elements can comprise a first return element, having a central position along the defined dimension, and at least one second return element, having a more extreme position along this same dimension, the first return element having a stiffness coefficient greater than the at least one second return element.

Furthermore, the electrochemical cell can comprise an electrically insulating leaf disposed around the plurality of electrodes so as to be interposed between the plurality of electrodes and the shell.

The invention relates also to an electrical energy storage device, notably intended for a motor vehicle, comprising at least one electrochemical cell as explained above.

The invention relates also to a hybrid or electric motor vehicle, comprising at least one electrochemical cell and/or at least one electrical energy storage device according to the invention.

The invention relates finally to a method for manufacturing an electrochemical cell as explained previously, comprising:
a step of positioning of the at least one return element on a tool, notably in the first configuration;
a step of positioning of the shell around the plurality of electrodes;
a step of placement of the assembly formed by the plurality of electrodes and by the shell facing the at least one return element, notably such that the shell and the at least one return element are concentric; then
a step of deformation of the at least one return element, notably during which the return element is displaced by a translational movement relative to the shell, such that the at least one return element surrounds the shell and the plurality of electrodes; then
a step of insertion of the assembly formed by the plurality of electrodes, the shell and the at least one return element in the rigid packaging.

Other details, features and advantages will emerge more clearly on reading the detailed description given hereinbelow, in an indicative and nonlimiting manner, in relation to the different exemplary embodiments illustrated in the following figures:

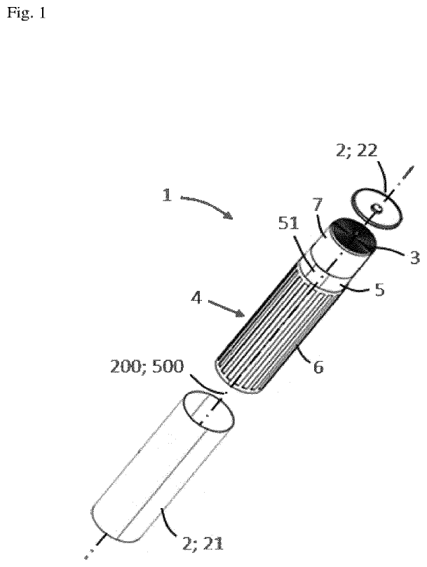

FIG. 1 is an exploded schematic representation of an embodiment of an electrochemical cell according to the invention.

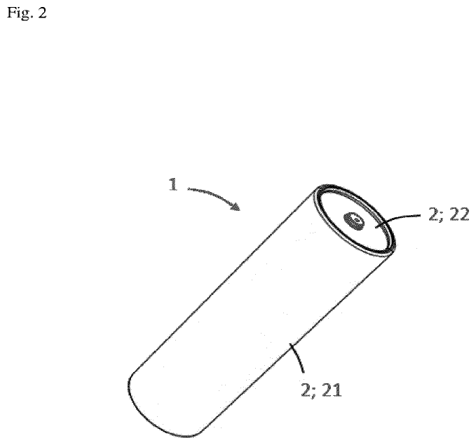

FIG. 2 is a perspective schematic representation of the electrochemical cell.

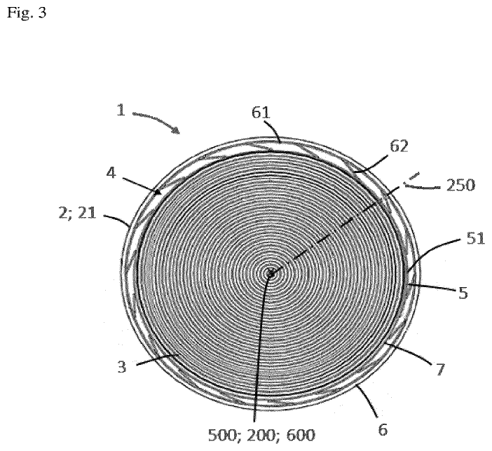

FIG. 3 is a cross-sectional schematic representation of an electrochemical cell comprising a return element according to a first embodiment.

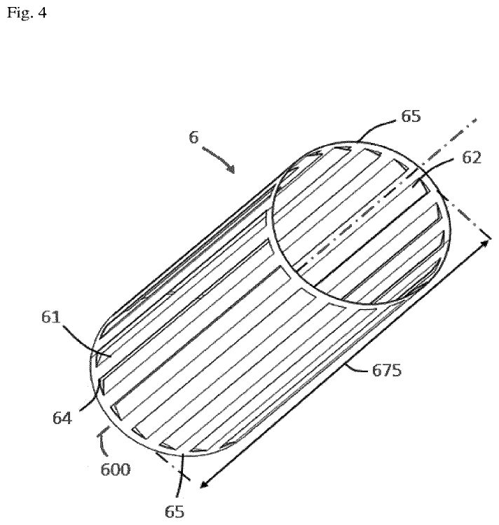

FIG. 4 is a perspective view of the return element according to the first embodiment.

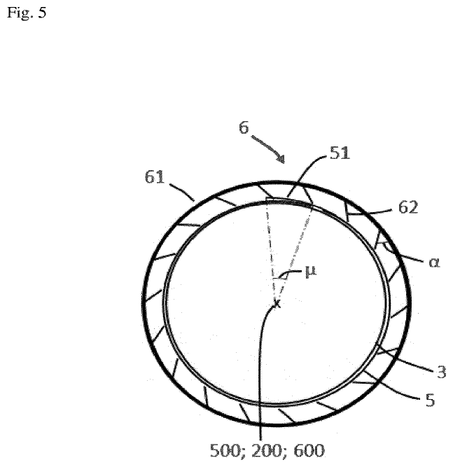

FIG. 5 is a schematic representation of the electrochemical cell illustrated in FIG. 3, when the return element is in a first configuration.

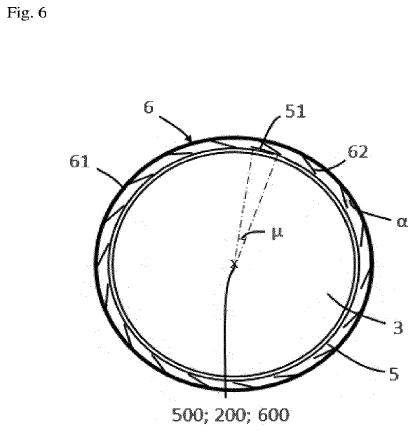

FIG. 6 is a schematic representation of the electrochemical cell illustrated in FIG. 3, when the return element is in a second configuration.

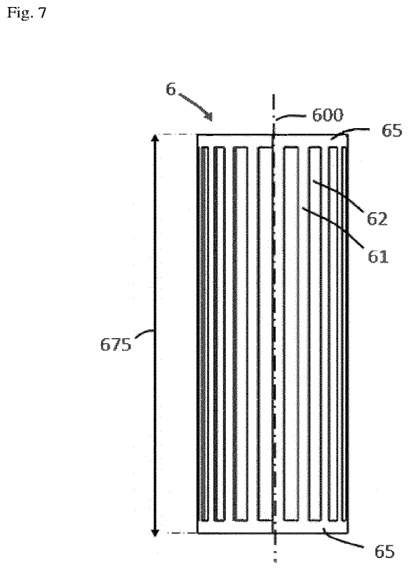

FIG. 7 is a lateral schematic representation of the return element according to the first embodiment.

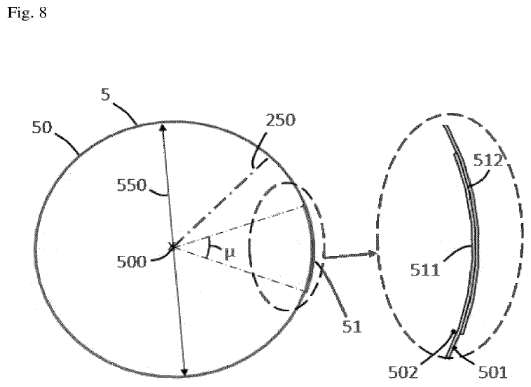

FIG. 8 is a top view schematic representation of a shell of the electrochemical cell.

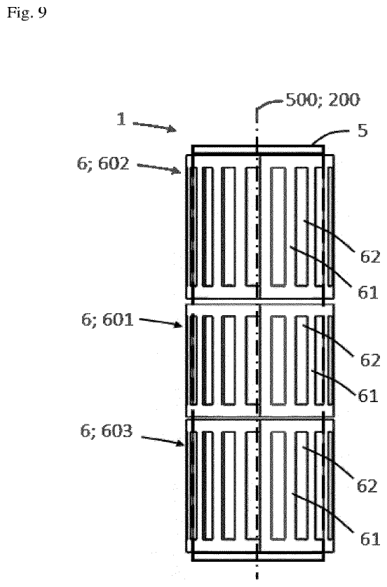

FIG. 9 is a schematic representation of an alternative embodiment of the electrochemical cell.

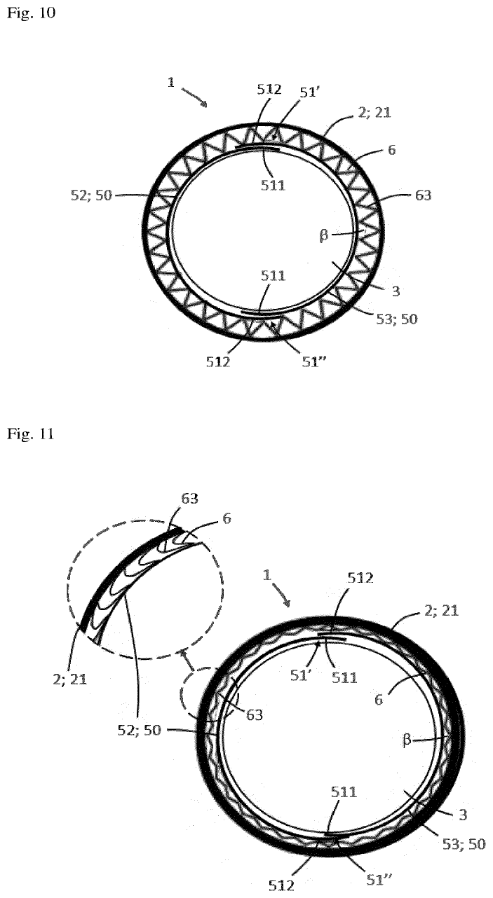

FIG. 10 is a schematic representation of an electrochemical cell comprising a return element according to a second embodiment, when it is in the first configuration.

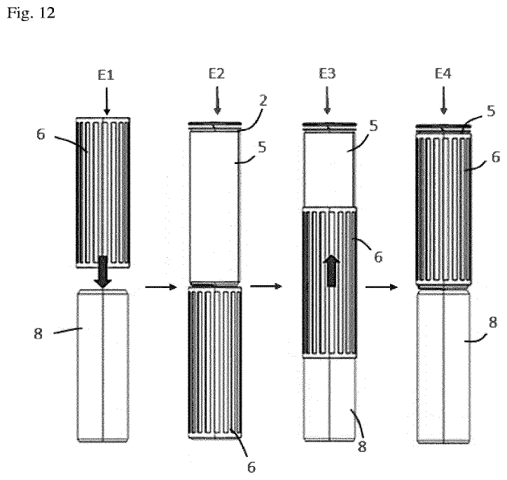

FIG. 11 is a schematic representation of an electrochemical cell comprising a return element according to the second embodiment, when it is in the second configuration.

FIG. 12 is a schematic representation of steps of a method for manufacturing an electrochemical cell according to the invention.

FIGS. 1 and 2 present an example of production of an electrochemical cell 1 according to an embodiment of the invention for an electrical energy storage device. The energy storage device, also called “battery” or “electric battery”, comprises a plurality of electrochemical cells 1 and can be intended, as a nonlimiting example, for a motor vehicle, notably a vehicle with hybrid or electric drive. It should be noted that, in all the figures, the dimensions and spacings separating the different components may be exaggerated for the purposes of clarity.

The electrochemical cell 1 is capable of storing energy in chemical form and of restoring it in the form of an electric current. The electrochemical cells can for. example be of the “lithium-ion”, also called “li-ion”, type. Generally, the electrochemical cell 1 comprises a rigid packaging 2, a plurality of electrodes 3, and a compression device 4 for the plurality of electrodes 3.

The rigid packaging 2 notably comprises a housing 21 capable of receiving at least the plurality of electrodes 3 and defining a negative terminal of the electrochemical cell 1. The packaging 2 further comprises a cover 22 configured to cooperate with the housing 21 in order to define, once joined to the latter, a hermetically sealed space in which the plurality of electrodes 3 extends. The electrochemical cell 1 can thus have a cylindrical structure, notably with circular base, or a prismatic structure, that is to say with polygonal base, notably square or rectangular. The packaging 2, notably the housing 21 and/or the cover 22, can for example be produced in nickel-plated aluminum or in a polymer material. Thus, a “rigid” packaging 2 is understood to be one that can be deformed little or even not at all, notably little because of the material or materials used for the production of the packaging.

The plurality of electrodes 3 comprises at least one anode and one cathode spaced apart by an electrically insulating separation element, not represented, and is arranged so as to exhibit an alternation of an anode and a cathode. The plurality of electrodes 3 can be disposed according to a winding, as illustrated in FIGS. 1 to 12, or, alternatively, according to a stack. According to another alternative that is not represented, the plurality of electrodes 3 can be disposed according to a combination of windings and of stacks. Notably, when the plurality of electrodes 3 is disposed according to a winding, the latter is centered on an axis of extension 200 whereas, when the plurality of electrodes 3 is arranged according to a stack or a combination of stacks and of windings, the latter can extend along such an axis of extension 200. This arrangement by stacking can notably be found in the case of the prismatic electrochemical cells, which are not represented.

Optionally, the electrochemical cell 1 can be at least partially filled with an electrolyte, for example an organic electrolyte, soaking the plurality of electrodes 3. The electrolyte can, as a nonlimiting example, consist of lithium salts (LiPF₆, LiBF₄, LiClO₄, LiTFSI, LiFSI, LiBOB) dissolved in one or more organic solvents such as carbonates of dimethyl, ethylene, diethyl, propylene or acetonitrile.

The compression device 4 according to the invention comprises a shell 5 and at least one return element 6.

The shell 5 is produced in a metal material, such as stainless steel. It can comprise one or more parts 50, notably one or more plates or platelets disposed relative to one another so as to be inscribed in a shell form 5 and configured to cooperate with one another. The shell 5 can, for example, be initially produced in a flat or substantially flat part then shaped or disposed in order to adopt the form of a shell 5, notably around an axis.

The shell 5 is configured to surround the plurality of electrodes 3 along an outline of the winding or of the stack of electrodes 3. In other words, in a plane orthogonal to the axis of extension 200, the shell is configured to surround the plurality of electrodes along a perimeter of the base of the winding or of the stack of electrodes. The shell 5 is configured to have a form 15 complementing, or substantially complementing, the winding or the stack of the plurality of electrodes 3 in order to maximise a contact surface, direct or indirect, with the latter. For example, when the plurality of electrodes 3 is arranged according to a winding, the shell 5 preferentially has a circular base. Conversely, 20 when the plurality of electrodes 3 is arranged according to a stack, the shell 5 has a polygonal base, notably square or rectangular. Notably, the shell 5 is centered on a main axis 500, which can, in particular, coincide 25 with the axis of extension 200 of the plurality of electrodes 3.

The shell 5 is particularly dimensioned and shaped such that, when it is disposed in the electrochemical cell 1, 30 it has a closed form along at least the outline, or the perimeter, of the plurality of electrodes 3. It has at least one area of overlap 51 of a plurality of distinct portions, specific to one or more parts 50 of the shell 5. “Overlap” is understood to be a superpositioning of a 35 plurality of portions of the shell 5 along a radial axis 250, orthogonal to the axis of extension 200 and/or to the main axis 500. In the case of a shell 5 comprising a single part 50, as illustrated in FIGS. 2, 5, 6 and 8, a first extreme portion 511 and a second extreme portion 512, opposite one another within the part 50 forming the shell 5, extend superposed with respect to one another within the shell 5 when the latter is arranged in the electrochemical cell 1.

In particular, the shell 5 has a movable structure. The shell 5 is configured in such a way that the portions 511, 512 of a same area of overlap 51 are displaced relative to one another based on the volume variations of the plurality of electrodes 3 observed in operation, or even because of the ageing, of the electrochemical cell 1. Thus, in order to accommodate the expansion or the contraction by volume of the electrodes during the charging and the discharging of the electrochemical cell 1 respectively, a main dimension 550 of the base of the shell 5 is made to vary. “Main dimension” is understood notably to be a diameter of a circular base, in the case of a cylindrical cell, or a diagonal of a polygonal base in the case of a prismatic cell. Such a main dimension 550 will thus increase with the expansion of the volume of the plurality of electrodes, and, conversely, decrease with the contraction thereof.

The result thereof is that the at least one area of overlap 51 has a surface that is variable according to the volume of the plurality of electrodes 3. The surface of the area of overlap 51 is maximal when the volume of the plurality of electrodes 3 is minimal, for example in the case of an electrochemical cell 1 in discharging phase and/or at the start of life. The main dimension 550 of the shell 5 is then also minimal. When the volume of the plurality of electrodes 3 increases, for example during the charging of the electrochemical cell 1 and/or because of the ageing thereof, the first portion 511 and the second portion 512 are displaced relative to one another because of the effort exerted by the plurality of electrodes 3 on the shell 5. The surface of the area of overlap 51 is then reduced. Notably, a minimum surface value can be predefined previously based on a maximum volume of the plurality of electrodes, permitted by the cell, such a volume being able, for example, to be conditioned by the dimensions of the packaging 2 and/or of the return element 6, as explained further hereinbelow.

Preferentially, the area of overlap 51 can be configured so as to be inscribed in an angular segment u, derived from the main axis 500, of between 10 and 30°, even between 10 and 20°, notably when the surface of the area of overlap 51 considered is minimal. The aim of such an arrangement is notably to prevent an abnormal displacement of the portions 511, 512 of the shell 5 and the appearance of areas of the outline of the plurality of electrodes that are “bare”, that is to say not surrounded by the shell 5 along the perimeter considered.

Thus, the shell 5 is advantageously configured to allow the respiration of the electrochemical cell 1, its form being adapted to the volume variation of the plurality of electrodes 3 both in the course of the usage cycles thereof, and over its life. The operation of the shell 5 relative to the volume variations, notably to a volume contraction, of the plurality of electrodes 3 will be detailed further hereinbelow.

Optionally, but preferentially, the electrochemical cell 1 can comprise, in addition, an electrically insulating leaf 7 disposed around the plurality of electrodes 3 so as to be interposed between the plurality of electrodes 3 and the shell 5 along the radial axis 250. Notably, such a leaf 7 can be produced in polyester, for example in Mylar®. Such a leaf 7 can be an element that is added and disposed so as to extend around the winding or the stack of electrodes 3 in order to prevent a direct contact between the shell 5 and the latter as well as the frictions thereof or short-circuits. Alternatively, such a leaf 7 can correspond to an extreme part of the insulating element incorporated in the winding or in the stack of electrodes 3 in order to separate a cathode and an adjacent anode. The insulating element is then dimensioned so as to make it possible to surround the stack or the winding of electrodes 3.

According to an alternative embodiment, as can be seen in the FIGS. 10 and 11, the shell 5 can comprise a plurality of parts 50, notably plates or platelets. These parts 50, that are movable relative to one another, are configured to cooperate together and to be inscribed in a form defining the shell 5. For example, as illustrated, said parts 50 correspond to parts of a cylinder disposed so as to be inscribed in a cylindrical or substantially cylindrical shell 5 form. A similar principle can also be implemented for a prismatic structure.

Like what has been previously explained, the shell 5 extends along the outline, or the perimeter, of the plurality of electrodes 3, and surrounds the plurality of electrodes 3. It then has a plurality of areas of overlap 51, the number of areas of overlap being notably equal to the number of parts 50 of the shell 5. According to the nonlimiting example illustrated, a first plate 52 and a second plate 53 each comprise a first extreme portion 511 and a second extreme portion 512, that are opposite within the plate considered. The first extreme portion 511 of the first plate 52 and the second extreme portion 512 of the second plate 53 are disposed so as to form a first area of overlap 51′, while the first extreme portion 511 of the second plate 53 and the second extreme portion 512 of the first plate 52 are disposed so as to form a second area of overlap 51″.

Preferentially and as explained previously, the first area of overlap 51′ and the second area of overlap 51″ can be configured so as to be inscribed in an angular segment, derived from the main axis 500, of between 10 and 30°, notably 10 and 20°, notably when the surface of the area of overlap considered is minimal.

Preferentially also, in order to optimise the contact surface between the parts 50 of the shell 5 and the plurality of electrodes, the different parts of the shell 5 are disposed such that portions 511, 512 of a same part 50 have an alternation of their position from one area of overlap 51 to another. For example, in the example illustrated, the first portion 511 of the first plate 52 is interposed between the plurality of electrodes 3 and the second portion 512 of the second plate 53 along the radial axis 250 in the first area of overlap 51′ while the second portion 512 of the first plate 52 is at least separated from the plurality of electrodes 3 by the first portion 511 of the second plate 53 in the second area of overlap 51″.

Furthermore, the shell 5 can be configured such that the first area of overlap 51 and the second area of overlap 51 have a positioning that is opposite or substantially opposite, for example diametrically opposite in the example illustrated, in the shell 5.

In the electrochemical cell 1, the shell 5 is interposed between the plurality of electrodes 3 and the at least one return element 6 along the radial axis 250. In other words, the at least one return element is interposed between the plurality of electrodes 3, and the shell 5, on the one hand, and at least a part of the packaging 2, notably the housing 21, on the other hand, along the radial axis 250. FIGS. 3 to 7 and 9 to 11 describe different embodiments and alternatives of the compression device 4. FIGS. 3 to 7 illustrate examples of a compression device 4 comprising a single return element 6 produced according to a first embodiment. FIGS. 10 and 11 illustrate an example of production of a second embodiment of the return element 6. FIG. 9 describes an alternative production of a compression device 4 comprising a plurality of return elements according to the first embodiment. It is understood that all of the description given with reference to a return element 6 can then extend to all or part of the plurality of return elements when the compression device 4 comprises a plurality thereof. Also, the compression device 4 can advantageously comprise a plurality of return elements 6 according to the second embodiment or, alternatively, a plurality of return elements 6 according to the first embodiment and/or the second embodiment.

Generally, the return element 6 is at least partly elastically deformable and is configured to be deformed between at least one first configuration and one second configurations according to the volume of the plurality of electrodes 3. It is s understood that such configurations represent the most extreme positions of the return element 6, at least one intermediate position being able to exist between said configurations. Notably, the first configuration can be considered as a so-called “rest” configuration to which the return element 6 returns, or aims to return, through its elastic properties when it is subjected to no effort or when such an effort decreases.

According to the first embodiment, illustrated in FIGS. 3 to 7, the return element 6 comprises a body 61 and a plurality of fins 62.

The body 61 has a closed structure and is configured so as to surround at least the assembly formed by the plurality of electrodes 3 and the shell 5. Notably, the body 61 has, preferentially, a form complementing that of the shell 5 and/or the plurality of electrodes 3. For example, when the shell 5 has a circular base, the same applies for the body 61 of the return element 6 so as to optimise the contact surfaces between the return element 6 and the shell 5. A similar principle applies with a shell 5 having a polygonal base, notably square or rectangular. That way, the body 61 can be centered on an axis 600, which can advantageously coincide with the axis of extension 200 of the plurality of electrodes 3 and/or the axis of extension 500 of the shell 5. In other words, the plurality of electrodes 3 and/or the shell 5 and/or the at least one return element 6 can be concentric, or substantially concentric.

The body 61 has, in particular, a rigid structure, that is to say notably a structure such that it is not deformed or is deformed little by the volume variation of the plurality of electrodes 3. The body can thus contribute to setting a limit on the tolerated maximum volume of the plurality of electrodes 3.

The plurality of fins 62 is linked to the body 61 and has an elastically deformable structure. Notably, the body 61 and the plurality of fins 62 form a one-piece assembly, that is say that they cannot be separated from one another without resulting in the destruction or the degradation of the return element 6. For example, the return element 6 can be produced from stainless steel, the plurality of fins 62 then being obtained by cutting into the body 61 and each fin 62 bordering an opening 64 included in the body 61.

The description hereinbelow is given with reference to a fin 62, but it is nevertheless understood that any feature relating to a fin can extend to all or part of the plurality of fins 62. The fin 62 has an elongate structure, for example a rectangular structure. In particular, the fin 62 can extend parallel, or substantially parallel, to the axis 600 of the body 61, notably along the latter.

The fin 62 can extend over all or part of a height 675 of the body 61, measured along the axis 600. According to a nonlimiting example, the fin 62 can extend at least over most of the height 675 of the body 61, for example over 70 to 95% of such a height. Alternatively, a plurality of fins 62 can extend in the continuity of one another along the height 675 of the body 61, each of said fins 62 then extending over a part of the height 675 of the body 61. In particular, the body 61 can comprise two extreme lips 65, opposite along the axis 600, and solid, that is to say without fins 62. Also, the return element 6 can extend over all or part of a height of the shell 5, such a height being defined along the main axis 500 on which the shell 5 is centered. In other words, the height 675 of the return element 6 can advantageously be less then or equal to the height of the shell 5, the latter distributing the efforts exerted by the return element 6. It is thus possible to reduce the weight of the assembly of the electrochemical cell by reducing the dimensions of the return element 6.

The fin 62 is linked to the body 61 on one of its sides and has an inclination α that is variable relative to the latter, thus rendering the fin elastically deformable. The aim of such a variability of the inclination α is to ensure a permanent contact between the fin 62 and the shell 5, independently of the volume of the plurality of electrodes 3 and of the main dimension 550 of the base of the shell 5. The result thereof is that the return element 6 exerts a constant and suitable compression on the plurality of electrodes 3 in order to maintain a suitable contact within the winding or the stack, and does so independently of the cycle of operation or of the wear of the electrochemical cell 1.

Notably, as illustrated in FIG. 5, a value of the inclination α is maximal when the at least one return element 6 is in the first configuration, that is to say when the volume of the plurality of electrodes and the main dimension 550 of the shell 5 are minimal. The fin 62 is then deployed and extends to protrude from the body 61 in order to exert a compression effort on the shell 5 and therefore, indirectly, on the plurality of electrodes 3. When the return element is displaced to the first configuration, that is to say that the fins are deployed and that the inclination α increases, the effort exerted by the return element 6 leads to the deformation of the body 5, and notably the displacement of the portions 511, 512 of the shell 5 relative to one another. The surface of the area of overlap increases and the main dimension 550 of the shell 5 is reduced. The return element 6 thus makes it possible to press the shell 5 against the plurality of electrodes 3 when their volume decreases, for example during a discharging phase, and allows the compression of the various components of the winding or of the stack in order to maintain the good contact thereof. A gap separating the shell 5 from the body 61 of the return element 6 then increases, until it is maximal when the return element 6 is in the first configuration. As a preferential example, the fin 62 can be configured so as to have a maximum inclination α that is strictly less than 90°, notably less than 85°.

Conversely, as explained above, when the volume of the plurality of electrodes 3 increases, the latter exerts an effort on the shell 5 which transmits it to the fin 62. The latter is then folded back toward the body 61 and the inclination α of the fin 62 is reduced with respect to that observed when the return element 6 is in the first configuration. The fin 62 thus folded back exerts, in return, a compression effort on the shell 5 and the plurality of electrodes 3, also making it possible to maintain the contact between the various components as explained previously. Notably, the value of the inclination α is minimal when the at least one return element 6 is in the second configuration, that is to say when the volume of the plurality of electrodes is maximal with respect to the maximum limit permitted by the compression device 4 and/or the packaging 2 of the cell.

In particular, when the volume of the plurality of electrodes is maximal, the minimum inclination α can be zero, such that the shell 5 comes to extend in contact with all or part of the plurality of fins 62 and the body 61.

The presence of the shell 5 in combination with the return element 6 and interposed between the latter and the plurality of electrodes 3 along the radial axis 250 thus advantageously makes it possible to ensure a uniform distribution of the compression effort exerted by the return element 6 on the plurality of electrodes 3. The effort exerted locally by the fins 62 on an outer face 501 of the shell 5 is in fact distributed in the structure of the shell 5. Since the contact surface between an inner face 502, opposite the outer face 501, of the shell 5 with the winding or the stack of electrodes 3 is greater than the contact surface observed between the fins 62 and the shell 5, it thus allows for a more uniform transmission of the effort exerted by the return element 6 on the plurality of electrodes 3.

To this end, the plurality of fins 62 of the return element 6 has, preferentially, a regular arrangement on the circumference of the body 61. In other words, the fins are regularly distributed in the body 61 and have a spacing separating the adjacent fins 62 that is regular. Similarly, the fins 62 of the plurality of fins 62 have, preferably, identical dimensions.

It should also be noted that the number of fins 62 illustrated, distributed along the circumference of the body 61, is in no way limiting. It is understood that the return element can comprise a distinct number of fins, notably greater than or less than that which is represented in the different figures.

As explained previously, the compression device 4 can, alternatively, advantageously comprise a plurality of return elements 6, each extending at least partly in contact with the shell 5. The above description applies mutatis mutandis to the present alternative, the features relating to the return element 6 being able to extend to all or part of the plurality of return elements 6. In the example illustrated in FIG. 9, the different return elements 6 are produced according to the first embodiment as described previously, that is to say that each comprises a body 61 and a plurality of fins 62.

The plurality of return elements 6 is disposed along at least one dimension, notably a longest dimension, of the plurality of electrodes 3 and/or of the shell 5. In other words, the plurality of return elements 6 can be disposed along the axis of extension 200 of the plurality of electrodes 3 and/or along the main axis 500 on which the shell 5 is centered. For example, such a dimension can be a height of the shell 5 and/or of the winding of electrodes 3 in the case of a cylindrical electrochemical cell 1 as illustrated. The plurality of return elements 6 can then extend over all or part of such a dimension, the different return elements 601, 602, 603 being able to be in contact with one another or not.

In this particular case, the compression device 4 comprises a first return element 601, a second return element 602 and a third return element 603 disposed along the main axis 500 of the shell 5 and along the axis of extension 200 of the winding of the plurality of electrodes 3, that is to say along their height, in contact with one another. In particular, the first return element 601 and/or the second return element 602 and/or the third return element 603 can be coaxial. Notably, they can be centered on the main axis 500 and/or on the axis of extension 200, that is to say that all or part of the plurality of return elements 6 and/or the shell 5 and/or the winding or the stack of electrodes 3 can be concentric.

The first return element 601 has a central position along the dimension considered, while the second return element 602 and the third return element 603 have a more extreme position along this same dimension. In other words, the second return element 602 and the third return element 603 extend on either side of the first return element 601 along the main axis 500 and/or the axis of extension 200.

In particular, the different return elements can be configured so as to have distinct characteristics, for example a distinct stiffness coefficient. Indeed, the variations of volume of the plurality of electrodes 3 can be non-uniform within a winding or a stack considered. Notably, it is known that such variations can be greater in a central part of the winding or of the stack. Given this, the compression device 4 can advantageously be configured such that the first return element 601, having a central positioning along the height of the plurality of electrodes 3 and/or of the shell 5, is characterized by a stiffness coefficient greater than that of the second return element 602 and/or of the third return element 603.

Such an arrangement thus makes it possible, on the one hand, to facilitate the assembly of the electrochemical cell 1 as detailed hereinbelow, and, on the other hand, to adapt the compression effort exerted on the shell 5 to any non-uniformity of the volume variation of the plurality of electrodes 3 observed in different parts of the winding or of the stack. It is understood that the example illustrated and previously detailed is in no way limiting. Also, when the compression device 4 comprises a plurality of return elements 6, it can comprise more or less than three return elements 6, and the preceding description then applies mutatis mutandis to such alternatives. Also, these different return elements 6 can then be disposed in contact with or at a non-zero distance from one another such that they extend over all or part of the height of the shell 5, the latter advantageously making it possible to distribute the efforts exerted by these different return elements.

According to another alternative, not represented, that can be implemented with the different embodiments and alternatives hereinabove, the electrochemical cell 1 can comprise, alternatively or in combination with the embodiments and alternatives explained previously, a plurality of shells 5, disposed along at least one dimension, notably the longest dimension, of the plurality of electrodes 3. In other words, the plurality of shells 5 can be disposed along the axis of extension 200 of the plurality of electrodes 3. The description given with reference to a plurality of return elements 6 applies here mutatis mutandis, the plurality of shells 5 extending, preferably, over all of the dimension considered of the plurality of electrodes.

FIGS. 10 and 11 schematically illustrate an example of production of an electrochemical cell 1 comprising a second embodiment of the return element 6, respectively when the latter is in the first configuration and in the second configuration. The electrochemical cell 1 illustrated is distinguished that from previously described through its return element 6, so the preceding description, notably relating to the structure of the electrochemical cell 1, to the number of return elements 6 or to the shell 5, applies mutatis mutandis to the description hereinbelow.

In the present embodiment, the return element 6, or alternatively at least one return element 6 of a plurality of return elements 6, has a so-called “accordion” structure. Notably, an accordion such structure is preferably inscribed in a form complementing the form of the shell 5 and/or of the plurality of electrodes 3. An “accordion” structure is understood to be a structure comprising a plurality of corrugations or, as illustrated, of folds 63 that are elastically deformable and defined by angles β with dimensions that are variable according to the volume of the plurality of electrodes 3, and therefore of the main dimension 550 of the shell 5. The folds or corrugations 63 are, here, defined in a plane orthogonal to the axis of extension 200 or to the main axis 500, but it is nevertheless understood that they can extend over all or part of the height of the return element 6. In other words, the different folds or corrugations 63 can extend along the axis of extension 200 of the plurality of electrodes 3 and/or the main axis of the shell 5. Also, it is understood that the form of the corrugations or folds 63 illustrated is in no way limiting. So, such corrugations or folds 63 can have, as illustrated, extreme parts, or vertices, that are pointed, rounded and/or flat, as well as straight portions, as illustrated, or curved portions.

Like what has been previously explained, the return element 6 according to the present embodiment can be produced in a metal material, notably stainless steel.

The angles β and/or the form of the folds 63 or corrugations vary according to whether the at least one return element 6 is in the first configuration, that is to say when the volume of the plurality of electrodes and the main dimension 550 of the shell 5 are minimal, or in the second configuration, that is to say when the volume of the plurality of electrodes 3 and the main dimension 550 of the shell 5 are the greatest. As an example, the angle value β specific to each fold or corrugation 63 when the return element 6 is at rest in the first configuration, as illustrated in FIG. 10, can be between 40 and 120°, even between 45 and 60°.

The accordion structure is thus such that the return element 6 surrounds the shell 5 and has an alternation between areas of contact and of non-contact with the shell 5, that is to say extending to a non-zero distance from the shell 5. Each fold or corrugation 63 of the return element 6 is, here, delimited by two areas of contact with the shell 5 along the outer outline, or the outer periphery, of the shell 5. Similarly, the return element 6 extends into contact with the packaging 2, notably an inner surface of the packaging, turned toward the plurality of electrodes 3.

The compression device 4 according to the second embodiment allows the variation of the volume of the winding or of the stack of electrodes 3 by implementing a greater or lesser crushing of the folds or corrugations 63 of the return element 6 between the shell 5 and the packaging 2, which are deformed, for example as illustrated in the inset of FIG. 11. The return element 6 thus bears against the packaging 2 and is constantly in contact, at least partial contact, with the shell 5 so as to allow the variation of volume of the plurality of electrodes 3 while exerting an effort, in the contact areas, on the shell 5 which is then transmitted uniformly to the plurality of electrodes 3. When the volume of the plurality of electrodes 3 increases, the main dimension 5 of the shell 5 does so also, crushing the return element 6 against the packaging 2. In the example illustrated, the straight portions of the folds 63 are deformed so as to form circular arcs and the angle β is then gradually reduced until the return element 6 reaches the second configuration. The return element 6 then exerts, in return, a compression effort on the shell 5 and the plurality of electrodes 3 as described above. Conversely, when the volume of the plurality of electrodes 3 decreases, the return element 6, bearing on the packaging 2, returns naturally to the first configuration. It exerts an effort on the shell 5 leading to the reduction of the main dimension 550 thereof and pressing it against the plurality of electrodes 3. The compression effort thus exerted locally by the return element 6 on the shell is then transmitted more uniformly to the plurality of electrodes, as for the first embodiment. It is understood that the example of crushing of the return element 6 is in no way limiting and is represented here as an indication.

The invention relates also to a method for manufacturing an electrochemical cell 1 as explained previously. The method illustrated in FIG. 12 notably implements a compression device 4 comprising a single return element 6 according to the first embodiment. It is nevertheless understood that the present method extends, mutatis mutandis, to the second embodiment and to the production alternatives comprising a plurality of return elements 6 and/or of shells 5.

The method can optionally comprise a step of stacking or. of winding of a plurality of electrodes 3 so as to have an alternation of an anode and of a cathode notably such that an anode and a cathode that are adjacent are separated by an insulating element as explained previously. Alternatively, the plurality of electrodes 3 can be supplied previously assembled according to a winding or a stack.

The method according to the invention comprises a step of positioning E1 of the at least one return element 6 on a tool 8, notably a tool for holding and/or guiding the at least one return element 6. When the compression device 4 comprises a plurality of return elements 6, the latter are disposed on a same tool 8. The tool can, as a nonlimiting example, have a form that at least partly complements the return element 6, in particular an inner face of the return element 6. For example for a return element 6 that is inscribed in a cylindrical or substantially cylindrical form, the tool can have a cylindrical form. In particular, such a tool can be configured so as to cooperate with the return element 6 when the latter is in the first configuration and/or in order to position the latter in the first configuration.

In parallel, the shell 5 is positioned around the winding or the stack of the plurality of electrodes 3. Such a positioning step can be performed before, at the same time as or after the positioning E1 of the at least one return element 6 on the tool.

When the electrochemical cell 1 comprises an electrically insulating leaf 7, the method according to the invention comprises, prior to the positioning of the shell 5 on the plurality of electrodes 3, a step of winding of the plurality of electrodes 3 in the leaf 7. In other words, the shell 5 is then disposed around the assembly formed by the leaf 7 and the winding or the stack of electrodes 3 so as to be in direct contact only with the leaf.

The assembly formed by the plurality of electrodes 3 and the shell 5 is then placed E2 facing the at least one return element 6, held by the tool. In particular, such an assembly is disposed such that the shell 5 and the at least one return element 6 are concentric. In this particular case, the shell 5 and the return element 6 are both centered on the main axis 500 of the shell 5 and/or the axis of extension 200 of the winding of electrodes 3.

Then, the at least one return element 6 is deformed, in a deformation step E3, in order to be disposed so as to surround the shell 5. In the step E3, the at least one return element can be deformed and displaced E3 relative to the shell 5 so as to surround the shell 5 and the plurality of electrodes 3. Notably, the at least one return element 6 can be displaced by a translational movement along the main axis 500 of the shell 5 and/or of the axis of extension 200 of the winding or of the stack of electrodes 3.

The assembly formed by the plurality of electrodes, the shell 5 and the at least one return element 6 can then be inserted into the rigid packaging 2, notably into the housing 21. The cover 22 is then disposed so as to hermetically close the cell, then sealed. Alternatively, when the electrochemical cell 1 comprises an electrolyte, the latter is inserted into the housing 21 before or after the closure of the packaging 2 by injection such that the compression device 4 and the plurality of electrodes 3 are bathed in said electrolyte. The cover 22 can then be positioned and the packaging 2 closed and sealed.

The present invention thus proposes an electrochemical cell for an electrical energy storage device, notably intended for a motor vehicle, comprising a plurality of electrodes and a compression device suited to the volume variations of the plurality of electrodes observed in the course of the cycles of operation and the ageing of the electrochemical cell. The compression device notably comprises a shell and at least one return element, at least partly elastically deformable. Such a compression device advantageously allows a compression suited to the plurality of electrodes to be constantly exercised, in order to maintain the various elements thereof in contact with one another and thus allow a better uniformity of its operation, and therefore of its ageing, thus rendering it better suited to the new recharging modes.

The present invention should not however be limited to the means and configurations described and illustrated here and it extends also to any equivalent means or configuration and to any technically operative combination of such means. In particular, the form and the dimensions of the electric terminals or the number of electrodes can be modified without diminishing the invention inasmuch as they ultimately fulfil the functionalities described and illustrated in the present document.

1. An electrochemical cell (1) for storing electrical energy, characterized in that it comprises a plurality of electrodes (3), a compression device (4) for the plurality of electrodes (3) and a rigid packaging (2) capable of receiving the plurality of electrodes (3) and the compression device (4), the compression device (4) comprising:
at least one return element (6) that is at least partly elastically deformable configured to be deformed between a first configuration and a second configuration based on a volume of the plurality of electrodes (3), the at least one return element (6) being interposed between the plurality of electrodes and at least a part of the rigid packaging (2);
a metal shell (5) comprising one or more parts (50), the shell (5) being interposed between the at least one return element (6) and the plurality of electrodes (3) and the shell (5) surrounding the plurality of electrodes (3) so as to have at least one area of overlap (51) of two distinct portions of the shell (5) of which a surface varies according to the volume of the plurality of electrodes (3).

2. The electrochemical cell (1) as claimed in the preceding claim, wherein the at least one return element (6) comprises a rigid body (61) and a plurality of elastically deformable fins (62), linked to the body (61) and having an inclination (α) relative to the latter, a value of the inclination (α) being maximal when the at least one return element (6) is in the first configuration such that the plurality of fins (62) extends to protrude from the body (61), and a value of the inclination α being minimal when the at least one return element (6) is in the second configuration, at least the plurality of fins (62) extending into contact with the shell (5).

3. The electrochemical cell (1) as claimed in claim 1, wherein the at least one return element (6) has an “accordion” comprising a plurality of corrugations or of elastically deformable folds (63) of which a form and/or angles (β) vary according to the volume of the plurality of electrodes (3).

4. The electrochemical cell (1) as claimed in one of the preceding claims, of which the shell (5) is centered on a main axis (500), a minimal surface of the area of overlap (51) being delimited by an angular segment, derived from the main axis (500) and defined in a plane orthogonal to the main axis (500), of between 10 and 30°, notably 10 and 20°.

5. The electrochemical cell (1) as claimed in one of the preceding claims, wherein the plurality of electrodes (3) is disposed according to a winding centered on an axis of extension (200) and/or according to a stack extending along an axis of extension (200), the at least one return element (6) and/or the shell (5) being centered on such an axis.

6. The electrochemical cell (1) as claimed in one of the preceding claims, wherein the compression device (4) comprises a plurality of return elements (6) disposed along at least one dimension, notably a longest dimension, of the plurality of electrodes (3) and/or of the shell (5), the plurality of return elements (6) extending over all or part of said dimension.

7. The electrochemical cell (1) as claimed in the preceding claim, wherein the plurality of return elements (6) comprises a first return element (601), having a central position along the defined dimension, and at least one second return element (602, 603), having a more extreme position along this same dimension, the first return element (6) having a stiffness coefficient greater than the at least one second return element (602, 603).

8. The electrochemical cell (1) as claimed in one of the preceding claims, further an comprising electrically insulating leaf (7) disposed around the plurality of electrodes (3) so as to be interposed between the plurality of electrodes (3) and the shell (5).

9. An electrical energy storage device, notably intended for a motor vehicle, comprising at least one electrochemical cell (1) as claimed in one of the preceding claims.

10. A hybrid or electric motor vehicle, comprising at least one electrochemical cell (1) as claimed in claims 1 to 8 and/or at least one electrical energy storage device as claimed in claim 9.

11. A method for manufacturing an electrochemical cell (1) as claimed in one of claims 1 to 8, comprising:
a step of positioning (E1) of the at least one return element (6) on a tool (8), notably in the first configuration;
a step of positioning of the shell (5) around the plurality of electrodes (3);
a step of placement (E2) of the assembly formed by the plurality of electrodes (3) and by the shell (5) facing the at least one return element (6), notably such that the shell (5) and the at least one return element (6) are concentric; then
a step of deformation (E3) of the at least one return element (6), notably during which the return element (6) is displaced by a translational movement relative to the shell (5), such that the at least one return element (6) surrounds the shell (5) and the plurality of electrodes (3); then
a step of insertion of the assembly formed by the plurality of electrodes (3), the shell (5) and the at least one return element (6) in the rigid packaging (2).
